(19) United States
(12) Patent Application Publication
(10) Pub. No.: US 2015/0017345 A1
(43) Pub. Date: Jan. 15, 2015

(54) METHOD AND APPARATUS FOR APPLYING A SEALING

(71) Applicant: GM Global Technology Operations LLC, Detroit, MI (US)

(72) Inventors: Giorgio Candela, Turin (IT); Giuseppe Maccarrone, Torino (IT)

(21) Appl. No.: 14/322,615

(22) Filed: Jul. 2, 2014

(30) Foreign Application Priority Data
Jul. 3, 2013 (GB) 1311931.8

(51) Int. Cl. B05D 3/14; B05C 9/10; B05D 1/02; B05B 17/04; B05D 3/00; B05B 1/14; B05C 9/12

(52) U.S. Cl. CPC B05D 3/142; B05B 1/14; B05C 9/10; B05C 9/12; B05B 17/04; B05D 3/007; B05D 1/02
USPC 427/535; 118/620

(57) ABSTRACT

A method for applying a sealing is disclosed which includes applying a liquid sealant to a component in a predefined area of the component and treating the predefined area with a plasma beam prior to applying the liquid sealant and/or treating the liquid sealant with a water spray after applying the liquid sealant. An apparatus for applying a sealing to a component in accordance with this method is also disclosed.

### CROSS REFERENCE TO RELATED APPLICATION

This application claims priority to German Patent Application No. 1311931.8 filed Jul. 3, 2013, which is incorporated herein by reference in its entirety.

### TECHNICAL FIELD

The present disclosure relates to a method for applying a sealing to a component. The present disclosure further relates to an apparatus for applying a sealing to a component.

### BACKGROUND

Methods for applying a sealing to a component are known. In order to apply a sealing to a component, e.g. a motor casing or transmission casing, an apparatus is used, which includes a nozzle for dispensing a liquid sealant. The liquid sealant, e.g. a curable and/or room temperature vulcanizing sealant, is dispensed by the nozzle and applied to the component in a predefined area. When the liquid sealant is dispensed, the nozzle is moved in relation to the component, such that the liquid sealant is applied along a path. After the curing, the applied liquid sealant forms the sealing, which adheres to the predefined area and the component, respectively. Afterwards, a second component may be connected to the component with the sealing in between.

### SUMMARY

The present disclosure provides a method for applying a sealing to a component, which improves the adherence of the sealing to the component and which reduces the time before a second component could be connected to the component with the sealing in between. The present disclosure also provides an apparatus for applying a sealing to a component, which improves the adherence of the sealing to the component and which reduces the time before a second component could be connected to the component with the sealing in between.

An embodiment of the method is directed to a method for applying a sealing to a component. The method includes the step of applying a liquid sealant to a component in a predefined area of the component. The predefined area may, for example, be an elongated area or an area having the form of a path or a line. Before the liquid sealant is applied to the predefined area, the predefined area is treated with a plasma beam. It has been determined that the adherence of the sealing to the component could be improved with this step. Alternatively or additionally, a water spray treatment may be carried out, in which the liquid sealant is treated with a water spray after the liquid sealant has been applied to the component in the predefined area. It has been determined that the curing time of the liquid sealant, and thus the time before a second component could be attached to the component with the sealing in between could be reduced. Thus, the production time and the error rate could be reduced, while the tightness of the sealing between the two components is improved.

In a further embodiment of the method the liquid sealant is applied along a path by moving the point of contact of the liquid sealant along the component. In other words, the predefined area is elongated or has the form of a path or line. The point of contact of the liquid sealant describes a point on the component at which the liquid sealant is dispensed onto the component or the predefined area of the component. Further, the area of impact of the plasma beam and/or the area of contact of the water spray is moved along the same path. The area of impact of the plasma beam describes the area on the component in which the plasma beam impacts or impinges on the component or the predefined area of the component, while the area of contact of the water spray describes an area on the component and/or the applied liquid sealant in which the water is sprayed on the component or the predefined area of the component and/or the applied liquid sealant. It is an advantage of this embodiment, that only the necessary areas are treated with the plasma beam and/or the water spray, but not the whole component. It is preferred, if the area of impact of the plasma beam and/or the area of contact of the water spray only covers the predefined area or is slightly bigger than the predefined area.

In a further embodiment of the method the area of impact of the plasma beam is moved in a distance in front of the point of impact of the liquid sealant along the path and/or the area of contact of the water spray is moved in a distance behind the point of impact of the liquid sealant along the path, in order to achieve proper adherence and/or reduced curing time of the sealing and liquid sealant, respectively, in short time.

In a further embodiment of the method the application of the liquid sealant on the one hand and the treatment of the predefined area with the plasma beam and/or the treatment of the applied liquid sealant with the water spray on the other hand is carried out simultaneously for the same sealing. In other words, when producing a sealing from the liquid sealant, the application of the liquid sealant and the plasma treatment and/or the water spray treatment are carried out in a distance from each other, but nevertheless simultaneously. Thus, the production time is reduced.

In a further embodiment of the method the movements of the point of contact of the liquid sealant and the area of impact of the plasma beam and/or the area of contact of the water spray along the path are coupled. In other words the mentioned points of contact and impact may be at least partially moved together, if the point of contact of the liquid sealant is moved. Thus, the method could be carried out in a simple fashion.

In a further embodiment of the method the liquid sealant is applied along a non-linear, curved, ring-like and/or closed path.

In a further embodiment of the method the angular position of the area of impact of the plasma beam and/or the angular position of the area of contact of the water spray in relation to the point of contact of the liquid sealant is changed during movement of the point of contact of the liquid sealant. It is an advantage of this embodiment, that the area of impact of the plasma beam and/or the area of contact of the water spray could be held a distance apart from the point of contact of the liquid sealant without departing from the predefined area and/or from the applied liquid sealant, even if the liquid sealant is applied along a non-linear, curved, ringlike or closed path. It is rather possible to produce sealings having sharp bends or the like along the path.

In a further embodiment of the method in which a plasma treatment as well as a water spray treatment is provided, the angular positions of the area of impact of the plasma beam and of the area of impact of the water spray are changed independent of each other, in order to produce a variety of sealings, even if said sealing has sharp bends or the like along the path.

In a further embodiment of the method the angular position of the area of impact of the plasma beam and/or the angular position of the area of impact of the water spray is changed by moving the area of impact of the plasma beam and/or the area of impact of the water spray in relation to the point of impact of the liquid sealant and/or on a path, preferably a ringlike, closed and/or circular path, formed around the point of impact of the liquid sealant.

A further embodiment of the method includes the further step of connecting the component to a second component with the sealing in between. As already mentioned before, the time between the application of the liquid sealant and connecting the component to a second component with the sealing in between could be drastically reduced, without losing the tightness of the sealing.

In a further embodiment of the method the component and/or the second component is a casing, preferably a motor casing and/or a transmission casing. Thus, casings being free from leakage could be produced.

In a further embodiment the liquid sealant used within the method is a room temperature vulcanizing sealant, i.e. a so-called RTV sealant, a curable sealant, a moisture-curable sealant, an acrylic sealant or a silicone sealant.

An embodiment of the apparatus is directed to an apparatus for applying a sealing. The apparatus includes a nozzle for applying a liquid sealant to a component in a predefined area of the component. The apparatus further includes a plasma emitter for emitting a plasma beam onto the predefined area prior to applying the liquid sealant and/or a spray nozzle for spraying a water spray onto the liquid sealant after applying the liquid sealant. The advantages described in connection with the embodiments of the method apply to the embodiments of the apparatus accordingly, such that it is pointed to the above described advantages for the sake of simplicity.

In a further embodiment of the apparatus the nozzle and the plasma emitter and/or the spray nozzle are movable in relation to the component, such that the point of contact of the liquid sealant is movable along a path on the component, while the area of impact of the plasma beam and/or the area of contact of the water spray is movable along the same path.

In a further embodiment of the apparatus the nozzle and the plasma emitter and/or the spray nozzle are arranged, such that the area of impact of the plasma beam is positioned in a distance in front of the point of contact of the liquid sealant along the path and/or the area of contact of the water spray is positioned in a distance behind the point of contact of the liquid sealant along the path.

In a further embodiment of the apparatus the movements of the point of contact of the liquid sealant and the area of impact of the plasma beam and/or the area of contact of the water spray along the path are coupled.

In a further embodiment of the apparatus a carrier is provided, to which the nozzle and the plasma emitter and/or the spray nozzle are mounted and which is movable in relation to the component in order to achieve a coupling of the movements of the point of contact of the liquid sealant and the area of impact of the plasma beam and/or the area of contact of the water spray along the path.

In a further embodiment of the apparatus the angular position of the area of impact of the plasma beam and/or the angular position of the area of contact of the water spray in relation to the point of impact of the liquid sealant is changeable.

In a further embodiment of the apparatus the plasma emitter and the spray nozzle are movable in relation to the nozzle and/or on a path, preferably a ring-like, closed and/or circular path, around the nozzle.

In a further embodiment of the apparatus the plasma emitter and the spray nozzle are movable independent of each other in relation to the nozzle and/or on the path around the nozzle.

### BRIEF DESCRIPTION OF THE DRAWINGS

The present disclosure will hereinafter be described in conjunction with the following drawing figures, wherein like numerals denote like elements, and:

FIG. 1 shows a schematic side view of an embodiment of the apparatus for applying a sealing;

FIG. 2 shows a schematic top view of the apparatus of FIG. 1 in a first phase of applying a sealing to a component;

FIG. 3 shows the apparatus of FIGS. 1 and 2 in a second phase of applying the sealing to the component; and

FIG. 4 shows the apparatus of FIGS. 1 to 3 in a third phase of applying the sealing to the component.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

FIG. 1 shows a schematic side view of an embodiment of the apparatus 2 for applying a sealing. In the figures, the opposing longitudinal directions 4, 6, the opposing width directions 8, 10 and the opposing depth directions 12, 14 of the apparatus 2 are indicated by corresponding arrows. The longitudinal axis 16 of the apparatus 2 extends in the longitudinal directions 4, 6.

The apparatus 2 includes a carrier 18 being movable in its longitudinal directions 4, 6, width directions 8, 10 and depth directions 12, 14 in relation to the component 20, to which the sealing should be applied. It should be understood, that the component 20 alone, the carrier 18 alone or the carrier 18 and the component 20 may be moved in the corresponding directions in order to achieve a movement of the carrier 18 relative to the component 20. In the shown embodiment, the component 20 is a casing, preferably a motor casing or transmission casing.

The apparatus 2 includes a nozzle 22 for applying a liquid sealant 24 to the component 20, a plasma emitter 26 for emitting a plasma beam 28 and a spray nozzle 30 for spraying a water spray 32. The nozzle 22, the plasma emitter 26 and the spray nozzle 30 are mounted to the carrier 18, such that they are moved in relation to the component 20 as soon as the carrier 18 is moved in relation to the component 20. While the nozzle 22 produces a point of contact 32 on the component 20 at which the liquid fluid 24 contacts on the surface 36 of the component, the plasma emitter 26 produces an area of impact 38 on the component 20 at which the plasma beam 28 impinges or impacts on the surface 36 of the component 20 and the spray nozzle 30 produces an area of contact 40 on the component 20 and the applied liquid sealant 24 at which the water spray 32 contact on the surface 36 of the component 20 and the applied liquid sealant 24.

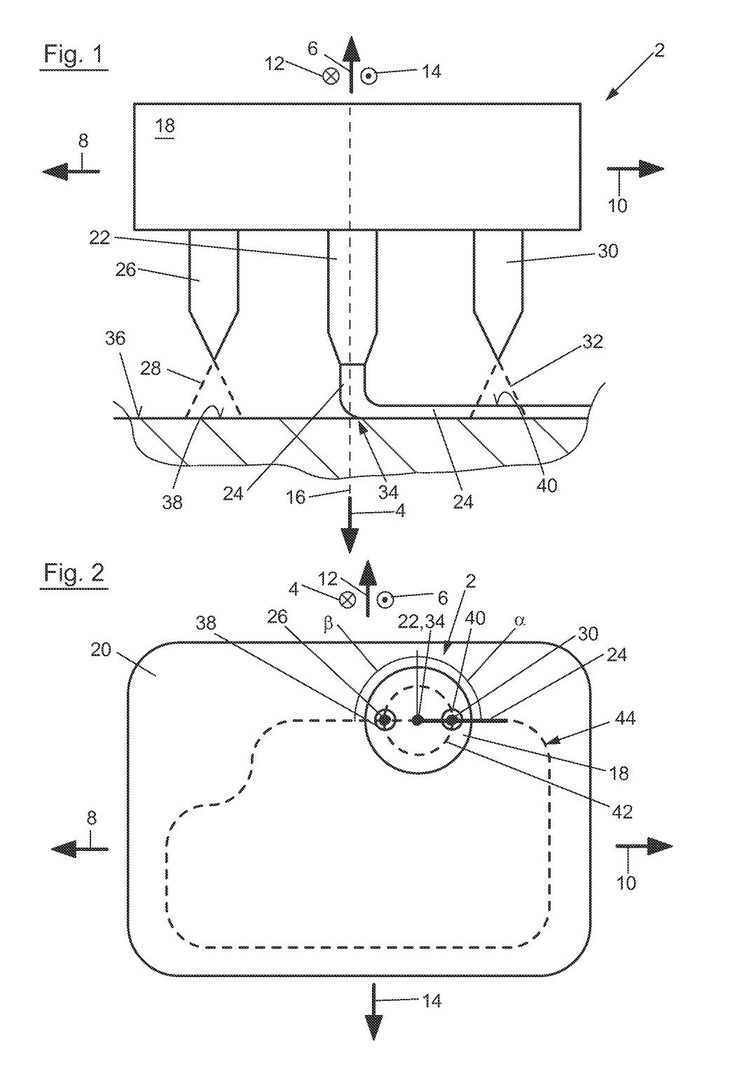

The nozzle 22 is mounted to the carrier 18 in the area of its longitudinal axis 16, while the plasma emitter 26 and the spray nozzle 30 are offset in relation to the nozzle 22 and the longitudinal axis 16, respectively. The plasma emitter 26 and the spray nozzle 30 are oriented in angular positions in relation to the longitudinal axis 16 and the nozzle 22, respectively, said angular positions being represented by the angles α and β in FIGS. 2 to 4, respectively. However, the plasma emitter 26 and the spray nozzle 30 are movable in relation to the nozzle 22, in this case on a ring-like, closed and circular path 42 around the nozzle 22, the circular path 42 being represented by a dotted line in FIGS. 2 to 4. Thus, the angular position of the area of impact 38 of the plasma beam 28 and the angular position of the area of contact 40 of the water spray 32 in relation to the point of contact 34 of the liquid sealant 24 is changeable by rotating the plasma emitter 26 and the spray nozzle 30 around the longitudinal axis 16 and the nozzle 22, respectively. In the shown embodiment, the circular path 42 of the plasma emitter 26 corresponds to the circular path 42 of the spray nozzle 30; however, this is not mandatory. Further, the plasma emitter 26 and the spray nozzle 30 are movable independent of each other along the circular path 42 around the nozzle 22.

The liquid sealant 24 is applied in a predefined area of the surface 36 of the component 20. In the shown embodiment, the predefined area is a path 44 indicated by a dotted line in FIGS. 2 to 4. By moving the carrier 18 in its width directions 8 or 10 and/or its depth directions 12 or 14 the point of contact 34 of the liquid sealant 24 is moved along the path 44 on the surface 26 of the component 20 creating an elongated sealing. Due to the fact, that the plasma emitter 26 and the spray nozzle 30 are also mounted to the carrier, they are moved together with the nozzle 22. As can be seen in FIGS. 2 to 4, the path 42 is formed as a non-linear, curved, ring-like and closed path 42, while the plasma emitter 26 and the spray nozzle 30 are positioned in a distance apart from the nozzle 22. However, due to the fact that the angular position of the plasma emitter 26 and the spray nozzle 30 may be changed, the area of impact 38 of the plasma beam 28 and the area of contact 40 of the water spray 32 is movable along the same path 44.

The nozzle 22, the plasma emitter 26 and the spray nozzle 30 are arranged at the carrier 18, such that the area of impact 38 of the plasma beam 28 is positioned in a distance in front of the point of contact 34 of the liquid sealant 24 along the path 44 and the area of contact 40 of the water spray 32 is positioned in a distance behind the point of contact 34 of the liquid sealant 24 along the path 44. By mounting the nozzle 22, the plasma emitter 26 and the spray nozzle 30 to the carrier, the movements of the point of contact 34 of the liquid sealant 24, the area of impact 38 of the plasma beam 28 and the area of contact 40 of the water spray 32 along the path 44 are coupled, even though the distance along the path 44 may vary according to the course of the path 44.

Hereinafter, the mode of operation and an embodiment of the method for applying a sealing to the component 20 will be described with respect to FIGS. 1 to 4.

The nozzle 22 continuously discharges the liquid sealant 24, the liquid sealant 24 being a room temperature vulcanizing sealant and/or a curable sealant and/or a moisture-curable sealant and/or an acrylic sealant and/or a silicone sealant. The liquid sealant 24 is applied to the predefined area in the form of path 44 by moving carrier 18, i.e. the liquid sealant 24 is applied along the path 44 by moving the point of contact 34 of the liquid sealant 24 along the surface 36 of the component 20, while the area of impact 38 of the plasma beam 28 and the area of contact 40 of the water spray 32 are moved along the same path 44. The plasma beam 28 is continuously emitted by the plasma emitter 26, while the water spray 32 is continuously sprayed by the spray nozzle 30.

Thus, the predefined area in form of the path 44 is treated with the plasma beam 28 prior to applying the liquid sealant 22, while the liquid sealant 24 is treated with the water spray 32 after applying the liquid sealant 24. However, the application of the liquid sealant 24 on the one hand and the treatment of the predefined area with the plasma beam 28 and the treatment of the applied liquid sealant 24 with the water spray 32 on the other hand is carried out simultaneously for the same sealing by coupling the movements of the point of contact 34 of the liquid sealant 24 and the area of impact 38 of the plasma beam 28 and the area of contact 40 of the water spray 32 along the path 44.

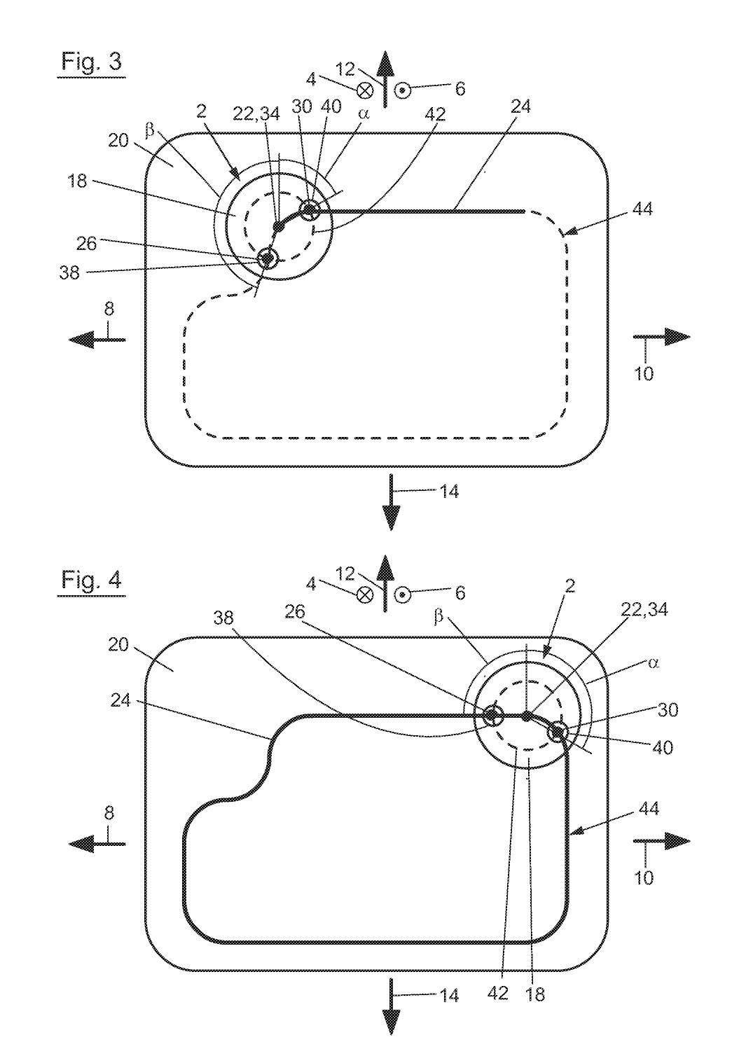

If a curved or bend section of the path 44 is reached, the angular position of the plasma emitter 26 and its area of impact 38 and/or the angular position of the spray nozzle 30 and its area of contact 40 in relation to the nozzle 22 and its point of contact 34 is changed during movement of the nozzle 22 and its point of contact 34 along the path 44 by increasing or decreasing the corresponding angle a and p, respectively, as can especially be seen in FIG. 3 and 4. In other words, the angular position of the area of impact 38 of the plasma beam 28 and/or the angular position of the area of contact 40 of the water spray 32 is changed by moving the area of impact 38 of the plasma beam 28 and/or the area of contact 40 of the water spray 32 in relation to the point of contact 34 of the liquid sealant 24 on the circular path 42 formed around the point of contact 34 of the liquid sealant 24.

The treatment of the predefined area and the path 44, respectively, with the plasma beam 28 has the advantage that the adherence of the liquid sealant 24 and—after curing of the liquid sealant 24—the adherence of the sealing to the surface 36 of the component 20 is improved. The treatment of the applied liquid sealant 24 with the water spray helps to reduce curing time of the liquid sealant, so that the time before a second component (not shown) could be connected to the component 20 with the sealing in between is also reduced.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-13. (canceled)

14. A method for applying a sealing to a component comprising:
treating a predefined area of a component with a plasma beam to provide a treated predefined area;
applying a liquid sealant to the component in the treated predefined area.

15. The method for applying a sealing according to claim 14, wherein the liquid sealant is applied along a path by moving the point of contact of the liquid sealant along the component, while an area of impact of the plasma beam is moved along the same path.

16. The method for applying a sealing according to claim 15, wherein the area of impact of the plasma beam is moved a distance in front of the point of contact of the liquid sealant along the path.

17. The method for applying a sealing according to claim 14, wherein an application of the liquid sealant and a treatment of the predefined area with the plasma beam is carried out simultaneously for the same sealing.

18. The method for applying a sealing according to claim 14, wherein the path along which the liquid sealant is applied is selected from the group consisting of a non-linear path, a curved path, a ring-like path and a closed path, and wherein an angular position of the area of impact of the plasma beam in relation to the point of contact of the liquid sealant is changed during movement of the point of contact of the liquid sealant.

19. The method for applying a sealing according to claim 18, wherein the angular position of the area of impact of the plasma beam is changed by moving the area of impact of the plasma beam in relation to the point of contact of the liquid sealant and on a path selected from the group consisting of a non-linear path, a curved path, a ring-like path and a closed path and defined around the point of contact of the liquid sealant.

20. The method for applying a sealing according to claim 18, wherein the liquid sealant is selected from the group consisting of a room temperature vulcanizing sealant, a curable sealant, a moisture-curable sealant, an acrylic sealant a silicone sealant, and combination thereof.

21. The method for applying a sealing according to claim 14, further comprising treating the liquid sealant with a water spray after applying the liquid sealant to the component.

22. The method for applying a sealing according to claim 21, wherein an application of the liquid sealant (24) and a treatment of the applied liquid sealant with the water spray is carried out simultaneously for the same sealing.

23. The method for applying a sealing according to claim 21, wherein the liquid sealant is selected from the group consisting of a room temperature vulcanizing sealant, a curable sealant, a moisture-curable sealant, an acrylic sealant a silicone sealant, and combination thereof.

24. The method for applying a sealing according to claim 21, wherein the liquid sealant is applied along a path by moving the point of contact of the liquid sealant along the component, while the area of contact of the water spray is moved along the same path.

25. The method for applying a sealing according to claim 24, wherein the area of contact of the water spray is moved in a distance behind the point of contact of the liquid sealant along the path.

26. The method for applying a sealing according to claim 24, wherein the path along which the liquid sealant is applied is selected from the group consisting of a non-linear path, a curved path, a ring-like path and a closed path, and wherein an angular position of the area of contact area of the water spray in relation to the point of contact of the liquid sealant is changed during movement of the point of contact of the liquid sealant.

27. The method for applying a sealing according to claim 26, wherein the angular position of the area of contact of the water spray is changed by moving the area of contact of the water spray in relation to the point of contact of the liquid sealant on a path selected is selected from the group consisting of a non-linear path, a curved path, a ring-like path and a closed path.

28. A method for applying a sealing to a component comprising:
treating a predefined area of a component with a plasma beam to provide a treated predefined area;
applying a liquid sealant to the component in the treated predefined area; and
treating the liquid sealant with a water spray after applying the liquid sealant to the component.

29. An apparatus for applying a sealing comprising:
a nozzle configured to apply a liquid sealant to a component in a predefined area of the component;
a plasma emitter configured to emit a plasma beam onto the predefined area prior to applying the liquid sealant to form a treated predefined area; and
a spray nozzle configured to spray a water spray onto the liquid sealant after the liquid sealant is applied to the component.

30. The apparatus according to claim 29, wherein the nozzle, the plasma emitter and the spray nozzle are movable in relation to the component, such that the point of contact of the liquid sealant is movable along a path on the component, while and area of impact of the plasma beam and an area of contact of the water spray is movable along the same path.

31. The apparatus according to claim 30, wherein the nozzle, the plasma emitter and the spray nozzle are arranged, such that the area of impact of the plasma beam is positioned in a distance in front of the point of contact of the liquid sealant along the path, and the area of contact of the water spray is positioned in a distance behind the point contact of the liquid sealant along the path.

32. The apparatus according to claim 30, further comprising a carrier to which the nozzle, the plasma emitter and the spray nozzle are mounted configured to move in relation to the component such that the movements of the point of contact of the liquid sealant, the area of impact of the plasma beam and the area of contact of the water spray along the path are coupled.

33. The apparatus according to claim 30, wherein an angular position of the area of impact of the plasma beam and an angular position of the area of contact of the water spray in relation to the point of contact of the liquid sealant is adjustable.
